(19) United States
(12) Patent Application Publication
(10) Pub. No.: US 2002/0077371 A1
(43) Pub. Date: Jun. 20, 2002

(54) GEL FORMULATIONS FOR HAZARDOUS PRODUCTS

(75) Inventors: SAMUEL T. GOUGE, RALEIGH, NC (US); LEONARD E. HODAKOWSKI, RALEIGH, NC (US); PAUL J. WEBER, DURHAM, NC (US); CHI-YU R. CHEN, RALEIGH, NC (US)

Correspondence Address: MORGAN & FINNEGAN, 345 PARK AVENUE, NEW YORK, NY, 10154

(73) Assignee: Rhone Poulenc AC Company

(21) Appl. No.: 08/317,830

(22) Filed: Oct. 4, 1994

Related U.S. Application Data
(63) Continuation of application No. 08/209,620, filed on Mar. 10, 1994, now abandoned.
Application No. 08/209,620 is a continuation of application No. 07/713,682, filed on Jun. 11, 1991, now abandoned.
Application No. 07/713,682 is a continuation-in-part of application No. 07/680,307, filed on Apr. 4, 1991, now abandoned.
Application No. 07/680,307 is a continuation-in-part of application No. 07/679,290, filed on Apr. 2, 1991, now abandoned.
Application No. 07/679,290 is a continuation-in-part of application No. 07/554,615, filed on Jul. 18, 1990.

(51) Int. Cl. C09K 3/00

(52) U.S. Cl. 516/98

(57) ABSTRACT

Formulations or compositions which are especially suitable to be contained in a water soluble or water dispersible bag containing a water dispersible organic gel. This gel is a continuous system comprised of effective amounts of hazardous product, a water soluble or water dispersible surfactant which contains a non ionic surfactant and optionally an anionic or amphoteric surfactant. This gel further consists of a gelling agent having, when it is solid, a particle size less than 100 microns.

This application is a continuation-part of U.S. patent application Ser. No. 07/680,307, filed Apr. 4, 1991, which is a continuation-in-part of U.S. patent application Ser. No. 07/679,290, filed Apr. 2, 1991 and U.S. patent application Ser. No. 07/554,615, filed Jul. 18, 1990, all of which are incorporated herein by reference.

### BACKGROUND OF THE INVENTION

I. Field of the Invention

The invention relates to new compositions comprising hazardous products and which are nevertheless safe for the handling and the environment.

II. Discussion of the Prior Art

At present, most hazardous liquids are stored in metal drums or, where smaller quantities are required, plastic containers.

Hazardous compounds, especially agrochemical compounds, are formulated in various compositions. Liquid compositions are most convenient for farmers because of the relative ease with which they can be handled. There are, nevertheless, difficulties in handling such liquid compositions. There is a danger of spillage or leakage if there are holes in the containers previously used or if they are dropped. Although secure containers resistant to shock can be used, in the event of an accident, for example during transportation, the risk remains of spillage or leakage with rapid loss of liquid, for example, leaking onto the ground.

It has been difficult to provide a formulation and a containing system which safeguards those handling it, including farmers and transporters, and the environment.

### SUMMARY OF THE INVENTION

The present invention provides formulations or compositions, which are especially suitable to be contained in a water soluble or water dispersible bag containing a water dispersible organic gel.

An object of the instant invention is to provide a new formulation system to contain agrochemical which is safe for everybody, and the environment.

Another object of the instant invention is to provide a new formulation system for agrochemicals which is readily, rapidly and easily soluble and/or dispersible in water.

Another object of the instant invention is to provide a new formulation system for agrochemicals which is as much condensed as possible, using the least amount of space.

Another object of the instant invention is to provide a new formulation system to contain hazardous compounds, e.g., agrochemicals which diminishes the risks of pollution.

It is also known that liquid agrochemicals may be contained in soluble bags or sachets made from films. However, such films may crack and break and thus, cause spillage of the agrochemicals they contain and create contamination problems. In fact, there are a variety of defects which may be present in films, which lead to weaknesses of film and consequently a potential source of leakage. The presence of air bubbles, or dust particles or foreign bodies, or gel particles or thin points on or in the film are all potential weak points. If a film with such a weak point is subjected to a lot of handling or physical shocks, the film may fail at that point. This is especially a problem in the agrochemical industry where containers may be subjected to rough or unsafe handling by distributors or farmers.

Another object of the instant invention is to avoid leakage through pinholes when an agrochemical containing bag is used. Such pinholes are rare, but only one pinhole among thousands of bags is enough to cause a lot of trouble, because the liquid going through the pinhole contaminates all of its environment.

Another object of the instant invention is to avoid breakage of the container which contains an agrochemical formulation. When the container is rigid, there is substantial possibility of simple breakage. With a liquid in a bag this possibility is somewhat reduced, but the liquid still transmits the shocks and there is the problem of hydraulic hammer effect. An object of the instant invention is to avoid, or at least to partially reduce, this hydraulic hammer effect. It has been proposed to reduce the possibility of breakage by means of an air space in the bag, but this represents some loss of storage space.

Another object of the present invention is to have a formulation or composition for hazardous compounds which dissipate, as much as possible, the energy of a shock to a container from outside.

Another object of the present invention is to provide a shock absorbing formulation system for containing agrochemicals, e.g., pesticides or plant protection agents or plant growth regulators.

It was known to use gel formulations for pharmaceuticals or cosmetics, but there is practically no risk of pollution or contamination of environment when handling such products, in contrast to pesticides and agrochemicals. Furthermore, the gels used for pharmaceutical or cosmetical purposes are generally water-based, so that it was unobvious to obtain gels which are convenient for water soluble sachets or bags, or for pesticide containing water soluble sachets or bags, or for shock absorption purposes for such bags.

Another possibility is to have agrochemicals in the form of wettable powders in a bag which may be water soluble. However, not all agrochemicals may be used under the form of a wettable powder, and even if these powders are wettable, the length of the time to get the powder wetted (wetting time) may cause some technical problems.

As already said, other containing systems for pesticides which are safe for the environment have been proposed in the past, especially those containing liquid in soluble bags or sachets. However, it may happen that if the bags have pinholes; the contained liquid leaks in such conditions and may pollute the environment.

Even though thixotropic liquid may be used, this possibility of leakage through pinholes remains when shipping, because the shipping creates a move which causes the thixotropic liquid to become more fluid.

Furthermore, even the non aqueous liquid contained in the known water soluble bags may have a low, but non zero, content of water, and this content, even though it is low, may cause bag breakage upon freezing.

The present invention seeks to provide a new formulation system for agrochemicals which quickly dissolves when put into water and which is not damaged by normal freezing.

A further object of the present invention is to provide a formulation system wherein less solvent is needed in the formulation of the pesticide, which is cost saving both in shipping and manufacturing.

The invention further seeks to provide a new formulation system for agrochemicals which reduces the risks of clogging the spray nozzles or the filters of spray tanks.

Other objects and advantages of the invention will be apparent from the description which follows. The objects of the invention can be achieved in full or in part by means of the invention.

### DETAILED DESCRIPTION OF THE INVENTION

The present invention provides formulations or compositions, which are especially suitable to be contained in a water soluble or water dispersible bag containing a water dispersible organic gel which is a continuous system comprising effective amounts of:

a hazardous product,

a water soluble or water dispersible surfactant which contains

a non ionic surfactant and

optionally an anionic or amphoteric surfactant, and

which is able to form about 50° C., preferably above 70° C., a liquid phase with the active ingredient,

a gelling agent which can be either liquid or solid at 23° C. and which is soluble at less than 10% in the liquid mixture of active ingredient and surfactant above 50° C., this gelling agent having, when it is a solid, a particle size lower than 100 microns, preferably less than 20 microns,

less than 3% by weight of water, preferably less than 1%.

The hereinbefore defined gel may optionally contain the further following components:

an organic solvent (where “solvent” is here defined to include a mixture of individual solvents) wherein the active ingredient is completely soluble at the given concentration,

a dispersant,

a secondary thickener,

other additives, such as stabilizer(s), antifoaming agent(s), buffer(s), antifreezing agents(s).

Among the gels of the invention as hereabove defined, some particular gels are preferred, especially those comprising:

5 to 95%, more preferably 25 to 80%, of the active ingredient,

1 to 50%, more preferably 2 to 15%, of the surfactant,

0.1 to 50%, more preferably 2 to 10%, of the gelling agent(s),

0.1 to 30%, more preferably 1 to 25% of the secondary thickener,

0 to 80% of the solvent, more preferably 3 to 50%,

0 to 20% of other additives (as herein before defined), preferably, 0.1 to 10%.

When gels of the invention contain a dispersant, they preferably comprise 1 to 25%, more preferably 2 to 8%, of the dispersant.

According to a particular feature of the invention, the components of the compositions are chosen in such a way that the gels have a viscosity of 600 to 30,000 centipoises, more preferably of 1000 to 12000 centipoises (those viscosities are Brookfield viscosities measured with a viscosimeter in form of a flat plate rotating at 20 revolutions per minute).

By the wording continuous system, it is meant a material which is visually homogeneous, that is to say which has the visual appearance to have only one physical phase; this does not exclude the possibility to have small solid particles dispersed therein, provided these particles are small enough not to constitute a visible separate physical phase.

It is known that a gel is generally a colloid in which the dispersed phase has combined with the continuous phase to produce a viscous, jelly-like product; it is also a dispersed system consisting typically of a high molecular weight compound or aggregate of small particles in very close association with a liquid. In the gels of the invention, the hazardous product (or active ingredient) may be in a soluble form, or in a dispersed form such as in a suspension.

According to a particular feature of the invention, the components of the compositions are chosen in such a way that the gels of the invention have a density greater than 1 gm/cc, preferably greater than 1.05 gm/cc.

According to another particular feature of the invention, the components of the compositions are chosen in such a way that the gels of the invention contained in the bags of the invention preferably have a spontaneity (as hereafter defined) less than 75, preferably less than 25.

The spontaneity is assessed according to the following method: A mixture of 1 ml gel with 99 ml water are put into a 150 ml glass tube which is stoppered and inverted through 1800 (upside down). The number of times required to completely disperse the gel is called the spontaneity.

By the word surfactant, it is meant an organic material which is able to substantially reduce the surface tension of water which 73 dynes/cm at 20° C.

Surfactants which are particularly suitable for the invention are defined by the following test: according to this test, the liquid active ingredient (50 g) and surface-active adjuvant (5 g) are added to an amount of water, at 50° C., which is sufficient to bring the volume of the mixture to 100 ml; the mixture is agitated so as to give a homogenous emulsion and this is left to stand for 30 minutes at 50° C. in a graduated cylinder; the amount of oily layer which may have separated out (and thus formed a distinct liquid phase) must then be less than 20 ml.

The surfactant which may be used in the invention may be selected among those of the following list (which is non limitative):

non ionic surfactant: alkanolamides, poly condensates of ethylene oxide with fatty alcohols, fatty esters, or fatty amines, or substituted phenols (particularly alkylphenols or arylphenols); bloc copolymers with ethoxy and propoxy groups; esters of fatty acids with polyols such as glycerol or glycol; polysaccharides; organopolysiloxanes; sorbitan derivatives; ethers or esters of sucrose or glucose;

anionic or amphoteric surfactants: salts of lignossulphonic acids, salts of phenyl sulphonic or naphthalene sulphonic acids, diphenyl sulfonates; alkylaryl sulfonates; sulfonated fatty alcohols or amines or amides; poly condensates of ethylene oxide with fatty acids and their sulfate or sulfonates derivatives; salts of sulphosuccinic or sulfosuccinamic acid esters; taurine derivatives (particularly alkyltaurates); betaïne derivatives; phosphoric esters of alcohols or of polycondensates of ethylene oxide with phenols; and sulphate, sulphonate and phosphate functional derivatives of the above compounds.

By the wording “gelling agent”, it is meant a material corresponding to the active ingredient in such a way that, when mixed, at 50/50 w/w and 25° C., with (and optionally ground with) an organic solvent wherein the active ingredient is soluble, a gel is obtainable. According to the present invention, a gel is essentially a material which has a phase difference phi between the controlled shear stress and the resulting shear strain such that tg(phi) is less than or equal to 1.5, preferably less than or equal to 1.2. Tg(phi) is the tangent of the angle phi (or phase difference). The measurement of phi is made by means of a rheometer having a flat fixed plate and a rotating cone above this plate such as the angle between them is less than 10°, preferably 4°. The cone is caused to rotate by means of a controlled speed motor; the rotation is a sinusoidal one, i.e., the torque and the angular displacement change as a sine function with time. This angular displacement corresponds to the hereabove mentioned shear strain; the torque of the controlled speed motor (which causes the angular displacement) corresponds to the hereabove mentioned controlled shear stress.

Gelling agents which may be used in the invention are tetramethyl decyne diol, ethoxylated dialkylphenol, methylated clay, propylene carbonate, hydrogenated castor oil, ethoxylated vegetable oil, diatomaceous earth, mixture of dioctyl sodium sulfosuccinate and sodium benzoate, and mixtures of hexanediol and hexynediol.

The expression “hazardous product” as used herein is defined as a product which may cause damage to the environment or be injurious to a person handling it.

According to one main and preferred feature of the invention, the hazardous product is an active ingredient which is an agrochemical, and more precisely a pesticide or a plant protection agent (including plant growth regulators or plant nutrient).

The invention is not limited to some specific agrochemicals; a list of the many agrochemicals which can be used in the invention includes:

Fungicides such as Triadimefon, Tebucconazole, Prochloraz, Triforine, Tridemorph, Propiconazole, Pirimicarb, Iprodione, Metalaxyl, Bitertanol, Iprobenfos, Flusilazol, Fosetyl, Propyzamide, Chlorothalonil, Dichlone, Mancozeb, Anthraquinone, Maneb, Vinclozolin, Fenarimol, Bendiocarb, Captafol, Benalaxyl, Thiram;

Herbicides (or defoliants) such as quizalofop and its derivatives, Acetochlor, Metolachlor, Imazapur and Imazapyr, Glyphosate and Gluphosinate, Butachlor, Acifluorfen, Oxyfluorfen, Butralin, Fluazifop-butyl, Bifenox, Bromoxynil, Ioxynil, Diflufenican, Phenmedipham, Desmedipham, Oxadiazon, Mecopropo, MCPA, MCPB, MCPP, Linuron, Isoproturon, Flamprop and Its Derivatives, Ethofumesate, Diallate, Carbetamide, Alachlor, Metsulfuron, Chlorsulfuron, Chlorpyralid, 2,4-d, Tribufos, Triclopyr, Diclofop-methyl, Sethoxydim, Pendimethalin, Trifluralin, Ametryn, Chloramben, Amitrole, Asulam, Dicamba, Bentazone, Atrazine, Cyanazine, Thiobencarb, Prometryn, 2-(2- chlorobenzyl)-4,4-dimethyl-1,2-oxazolidin-3-one, Fluometuron, Napropamide, Paraquat, Bentazole, Molinate, Propachlor, Imazaquin, Metribuzin, Tebuthiuron, and oryzalin;

Insecticides or nematicides such as Ebufos, Carbosulfan, Amitraz, Vamidothion, Ethion, Tgriazophos, Propoxur, Phosalonc, Permethrin, Cypermethrin, Parathion, Methylparathion, Diazinon, Methomyl, Malathion, Lindane, Fenvalcrate, Ethoprophos, Endrin, Endosulfan, Dimethoate, Dieldrin, Dicrotophos, Dichlorprop, Dichlorvos, Azinphos and Its Derivatives, Aldrin, Cyfluthrin, Deltamethrin, Disulfoton, Chlordimeform, Chlorpyrifos, Carbaryl, Dicofol, Thiodicarb, Propargite, Demeton, and Phosalone;

Plant growth regulators such as gibberllic acid, ethrel or ethephon, cycocel, Chlormequat, Ethephon, and Mepiquat.

In order to assess whether a surface-active adjuvant possesses dispersing properties and may be a dispersant according to the invention, the following test is carried out: an aqueous suspension (100 ml) containing kaolin or atrazine (50 g), in the form of solid particles having a particle size between 1 and 10 microns, and surface-active adjuvant (5 g) is left to stand at 20° C. for 30 minutes in a graduated cylinder (kaolin is used when the dispersing agent is able to disperse a hydrophilic solid. Atrazine is used when the dispersing agent is able to disperse a hydrophobic solid). After standing, 9/10th (nine-tenths) of the volume of the suspension, situated in the upper part of the suspension, is removed, without agitation, and the solids content (residue after evaporation of the water) of the remaining tenth is measured; this solids content must not exceed 12% by weight of the solids content of 100 ml of the suspension on which the test is carried out.

The dispersant which may be used in the invention may be selected among those of the following list (which is non limitative): salts of lignosulphonic acids such as calcium lignossulfonate, salts of phenyl sulphonic or naphthalene sulphonic acids, condensed naphthalene sulfonic acid; poly condensates of ethylene oxide with fatty alcohols or fatty acids or fatty esters or fatty amines, or substituted phenols (particularly alkyphenols or arylphenols); salts of sulphosuccinic acid esters, such as sodium sulfosuccinate; taurine derivatives (particularly alkyltaurates); phosphoric esters of alcohols or of polycondensates of ethylene oxide with phenols; esters of polyols and of fatty acids or sulphuric acid or sulphonic acids or phosphoric acids; glyceryl esters, especially esters with fatty acids such as glyceryl stearate; ethylene glycols; and the like.

The secondary thickener is a compound which increases the viscosity of a gel or a liquid.

The secondary thickener which may be used in the invention may be selected from among the following list (which is non limitative): fumed silica; hydroxyethyl cellulose, carboxy-methylcellose; organically modified attapulgite or montmorillonite clay; hardened castor oil; cetyl and stearyl alcohols or esters; polyethylene glycols; glyceryl hydroxystearate, polyvinylalcohol; salts of sulphosuccinic acid esters such as the dioctyl sodium sulfosuccinate; salts of benzoic acid such as sodium benzoate; and alkyl sulphates.

The gels of the invention can be prepared or manufactured by any known method. A convenient way is to mix together the different constituents of the mixture/composition and to stir them, optionally with grinding or milling and/or heating. The constituents of the composition may be added and mixed randomly or added in several various manners which more conveniently achieve the desired gel properties. As is known to one of ordinary skill in the art, such addition and mixing may be dependent upon the physical and chemical nature of the individual constituents, their combination(s), and the desired final gel. In this regard, sometimes it is easier to operate with a slow addition of the constituents of the composition.

The instant invention includes also containerization systems which comprise water soluble or water dispersible bags containing the gel formulations as hereabove defined.

The chemical nature of the enveloping film constituting the bags which may contain the composition/gels of the invention can vary quite widely. Suitable materials are water soluble (or possibly water dispersible) materials which are insoluble in the organic solvents used to dissolve or disperse the agrochemical active ingredient. Specific suitable materials include polyethylene oxide, such as polyethylene glycol; starch and modified starch; alkyl and hydroxyalkylcellulose, such as hydroxymethylcellulose, hydroxyethylcellulose, hydroxypropylcellulose; carboxymethylcellulose; polyvinylethers such as poly methyl vinylether; poly(2,4-dimethyl-6- triazolyethylene); poly(vinylsulfonic acid); polyanhydrides; low molecular weight urea-formaldehyde resins; low molecular weight melamine-formaldehyde resins; poly(2-hydroxyethyl methacrylate); polyacrylic acid and its homologs; but preferably the enveloping film comprises or is made from polyvinylalcohol (PVA).

Preferred material for constituting the bags for the gels of the invention are polyethylene oxide or methylcellulose, or polyvinylalcohol. When polyvinylalcohol is used, it is advantageously a 40-100%, preferably 80-99% alcoholsed or hydrolysed, polyvinyl acetate film.

The water soluble films which are used to make the water soluble bags are known. In order to make a bag, the film needs to be shaped (possibly partially sealed) and then filled with the gel. Generally the gels are able to flow, even if it is a slow rate due to the high viscosity. A container which is used to contain the gels cannot be easily emptied due to this high gel viscosity (that a reason why the gels were not used up to now in the agriculture). When filled, the bag have to be finally sealed, generally heat sealed, to be closed.

According to another feature, the bag of the invention is filled to at least 60% of capacity with the agrochemical composition-containing substance, more preferably to at least 70% of capacity, still more preferably 80 to 99% of capacity and most preferably 85 to 95% of capacity. The bag is preferably not filled to complete capacity because the unused capacity gives the bag shock resistance, i.e., resistance to breakage when dropped, transported or stored. This unused capacity may or may not contain air or an inert gas. An absence of air or inert gas in the unused capacity further improves shock resistance. However, in deciding how much unused capacity, or absence of air or inert gas, to provide, the advantages of shock resistance must be balanced against the need, if any, for shock resistance and the cost of providing shock resistance. For example, if the bag is stored and/or transported in a shock absorbing container, then it may not be as helpful to provide this unused capacity.

Also, the capacity to which the bag is filled, and whether the unused capacity does nor does not contain air or inert gas is affected by whether it is desired to have the bag sink or float. Whether the bag sinks or floats will depend not only on the unused capacity, but also the density of the bag contents.

Further information may be found in the following copending applications, the disclosures of which are incorporated herein by reference: application of Leonard E. Hodakowski, Chi-Yu R. Chen, Samuel T. Gouge and Paul J. Weber for “Gel Formulations for Use in Toxic or Hazardous Product Containerization Systems” filed Jun. 11, 1991; application of David B. Edwards, William J. McCarthy, Leonard E. Hodakowski, Chi-Yu R. Chen, Samuel T. Gouge and Paul J. Weber for “Laminated Bags for Containerization of Toxic or Hazardous Materials” filed Jun. 11, 1991;, application of Leonard E. Hodakowski, Chi-Yu R. Chen, Samuel T. Gouge and Paul J. Weber for “Water Dispersible Gel Formulations” filed Jun. 11, 1991; application of Leonard E. Hodakowski, Ricky W. Couch, Samuel T. Gouge and Robert C. Ligon for “Gel Formulations” filed Jun. 11, 1991, and application of Samuel T. Gouge and James E. Shue for “Bag In A Bag for Containerization of Toxic or Hazardous Material” filed Jun. 11, 1991.

The following examples are given for illustrative purposes and should not be understood as restricting the invention.

### EXAMPLE 1

A gel is made by stirring at 50° C. a mixture of:

Active ingredient: 2,4-D phenoxy benzoic acid isooctyl ester: 64.8%

Solvent: aromatic solvent with flash point of 65° C.: 24.2%

| Surfactant: a mixture of | |
|---|---|
| a non ionic/sulfonate blended emulsifier | 4% |
| and calcium alkylbenzene sulfonate | 1% |

Gelling agent: mixture of dioctylsulfosuccinate salt and sodium benzoate: 6%.

The mixture is stirred and shaken until each component is dissolved or dispersed.

During stirring, a dissolution appears, and thereafter a gelation. Gelation is increased during cooling at room temperature (20° C.).

The brookfield viscosity of the gel is 3000 centipoises.

The emulsion stability is good in the above described test.

1100 g of this gel are put in a 1 liter bag made of a film of PVA (88% hydrolysed polyvinyl acetate; cold water soluble; thickness: 55 microns). The bag, which is almost full (about 95% v/v), is heat sealed. The density both of the gel and of the bag containing the gel is 1.1.

The bag is then dropped 10 times from 1.2 m upon the ground. No breaking or leakage is observed.

The bag is put in a tank containing water under gentle agitation (that is to say such as that obtained with pump recycling). It is dispersed within a 3 minute interval. There is no clogging in the filter which is a 100 mesh screen.

Another bag made in the same way as the previous one is tested for pinhole protection. a needle (diameter: 0.6 mm) is passed through the bag. It is observed a small droplet which forms at the locus where the needle passed, but this droplet was small enough not to drop from the bag and not to flow along the bag.

### EXAMPLE 2

The procedure of example 1 is repeated, except a mixture containing the following adjuvants is used:

| Surfactant: | |
|---|---|
| non ionic/sulfonate blended emulsifier: | 5.2% |
| Gelling agent: | |
| tetramethyl decynediol | 30%. |

The brookfield viscosity of the gel is 3000 centipoises.

The emulsion stability is good in the above described test.

1100 g of this gel are put in a 1 liter bag made of a film of PVA (88% hydrolysed polyvinyl acetate; cold water soluble; thickness: 55 microns). The bag, which is almost full (about 95% v/v), is heat sealed. The density both of the gel and of the bag containing the gel is 1.1.

The bag is then dropped 10 times from 1.2 m upon the ground. No breaking or leakage is observed.

The bag is put in a tank containing water under gently agitation (that is to say such as that obtained with pump recycling). It is dispersed within a 3 minute interval. There is no clogging in the filter which is a 100 mesh screen.

### EXAMPLE 3

The procedure of example 1 is repeated, except a mixture containing the following adjuvants is used:

Surfactant: non ionic/sulfonate blended emulsifier: 21.5%.

and calcium alkylbenzene sulfonate: 3.7%

Gelling agent: ethoxylated dialkyphenol: 10%

The brookfield viscosity of the gel is 3000 centipoises.

The emulsion stability is good in the above- described test.

1100 g of this gel are put in a 1 liter bag made of a film of PVA (88% hydrolysed polyvinyl acetate; cold water soluble; thickness: 55 microns). The bag, which is almost full (about 95% v/v), is heat sealed. The density both of the gel and of the bag containing the gel is 1.1

The bag is then dropped 10 times from 1.2 m upon the ground. No breaking or leakage is observed.

The bag is put in a tank containing water under gentle agitation (that is to say such as that obtained with pump recycling). It is dispersed within a 3 minute interval. There is no clogging in the filter which is a 100 mesh screen.

### EXAMPLE 4

A gel is made by stirring at 50° C. a mixture of:

| active ingredient: | |
|---|---|
| bromoxynil acid (octanoate ester): | 18.65% |
| bromoxynil acid (heptanoate ester): | 13.85% |
| methylchloropropionic acid (isoctyl ester): | 37.4% |
| Solvent: | |
| aromatic solvent with a flash point of 38° C.: | 11.1% |
| Surfactant: | |
| non ionic/sulfonate blender emulsifier: | 13% |
| Gelling agent mixture: | |
| hydrogenated castor oil | 3% |
| ethoxylated vegetable oil | 3% |

These materials are mixed together while shearing with an attritor mixer. The product started to gel in a few minutes.

The brookfield viscosity of the gel is 3150 centipoises.

The emulsion stability is good in the above described test.

The spontaneity is 20.

1100 g of this gel are put in a 1 liter bag made of a film of PVA (88% hydrolysed polyvinyl acetate; cold water soluble; thickness: 55 microns). The bag, which is almost full (about 95% v/v), is heat sealed. The density both of the gel and of the bag containing the gel is 1.1 gm/cc.

The bag is then dropped 10 times from 1.2 m upon the ground. No breaking or leakage is observed.

The bag is put in a tank containing water under gentle agitation (that is to say such as that obtained with pump recycling). It is dispersed within a 10 minute interval. There is no clogging in the filter which is a 50 mesh screen.

### EXAMPLE 5

The procedure of example 4 is repeated, except a mixture containing the following components is used:

| Active ingredient: | |
|---|---|
| bromoxynil octanoate | 18.4% |
| bromoxynil heptanoate: | 14.0% |
| methyl chloropropionic acetic acid | 36.6% |
| (isooctyl ester) | |
| Surfactant mixture: | |
| non lonic/sulfonate blended emulsifier | 9.0% |
| Gelling agent: | |
| diatomaceous earth | 17.0% |
| and dioctyl ester of sodium sulfosuccinic acid | 2.0% |
| and sodium benzoate | |
| Dispersant: | |
| sodium sulfonate of naphthalene formaldehyde condensate | 3.0% |

These materials are mixed together while shearing with an attritor mixer. The product started to have the appearance of a smooth paste, and is a gel in a few minutes.

The brookfield viscosity of the gel is 9000 centipoises.

The emulsion stability is good in the above described test.

The spontaneity is 9.

1100 g of this gel are put in a 1 liter bag made of a film of PVA (88% hydrolysed polyvinyl acetate; cold water soluble; thickness: 55 microns). The bag, which is almost full (about 95% v/v), is heat sealed. The density both of the gel and of the bag containing the gel is 1.1 gm/cc.

The bag is then dropped 10 times from 1.2 m upon the ground. No breaking or leakage is observed.

The bag is put in a tank containing water under gentle agitation (that is to say such as that obtained with pump recycling). It is dispersed within a 10 minute interval. There is no clogging in the filter which is 50 mesh screen.

### EXAMPLE 6

The procedure of example 5 is repeated, except a mixture containing the following components is used:

| Active ingredient: | |
|---|---|
| bromoxynil octanoate | 31.5% |
| bromoxynil heptanoate | 31.5% |
| atrazine | 44.58% |
| Solvent: | |
| same as in example 1 | 23.25% |
| Gelling agent: | |
| mixture of dioctyl sodium sulfosuccinate and | 1.5% |
| sodium benzoate. | |
| Stabilizer: | |
| alkyl sulfate | 2.15% |
| Surfactants: | |
| ethoxylated/propoxylated block copolymer with alkylphenol | 3.6% |
| alkylarylsulfonate of an amine | 5% |
| Antifreeze agent: | |
| polyethylene glycol | 1% |
| Antifoam: | |
| polyorganosiloxane | 0.5% |

These materials are mixed together and passed through a bead mill. The product gets the appearance of a gelatineous mixture; after about 5 hours, it becomes much more viscous.

The brookfield viscosity of the gel is 9100 centipoises and is 5200 after stirring for 4 min.

The emulsion stability is good in the above described test.

The spontaneity is 11.

1100 g of the gel are poured into a 1 liter bag made of a film of PVA (88% hydrolysed polyvinyl acetate; cold water soluble; thickness: 75 microns). The bag, which is almost full (about 95% v/v), is heat sealed. The density both of the gel and of the bag containing the gel is 1.2 gm/cc.

The bag is then dropped 10 times from 1.2 m upon the ground. No breaking or leakage is observed.

The bag is put in a tank containing water under gentle agitation (that is to say such as that obtained with pump recycling). It is dispersed within a 5 minute interval. There is no clogging in the filter which is a 100 mesh screen.

### EXAMPLE 7

The procedure of example 6 is repeated, except a mixture containing the following components is used:

| Active ingredient: | |
|---|---|
| bromoxynil octanoate | 33.7% |
| methyl chloropropionic acetic acid (isooctyl ester): ester | 36.2% |
| Solvent: | |
| aromatic solvent with flash point of 65° C.: | 3.0% |
| Surfactant: | |
| non ionic/sulfonate blended emulsifier | 8.5% |
| and calcium dodecyl benzene sulfonate | 1.0% |
| Gelling agent: | |
| tetramethyl decyne diol | 17.6% |

These materials are mixed together while shearing with an attritor mixer. The product started to have the appearance of a smooth paste, and is a gel in a few minutes.

The brookfield viscosity of the gel is 2200 centipoises.

The emulsion stability is good in the above described test.

The spontaneity is 14.

1100 g of this gel are put in a 1 liter bag made of a film of PVA (88% hydrolysed polyvinyl acetate; cold water soluble; thickness: 55 microns). The bag, which is almost full (about 95% v/v), is heat sealed. The density both of the gel and of the bag containing the gel is 1.1.

The bag is then dropped 10 times from 1.2 m upon the ground. No breaking or leakage is observed.

The bag is put in a tank containing water under gentle agitation (that is to say such as that obtained with pump recycling). It is dispersed within a 5 minute interval. There is no clogging in the filter which is a 100 mesh screen.

### EXAMPLE 8

The procedure of example 7 is repeated, except a mixture containing the following components is used:

Active ingredient and solvent are the same as in example 8, and amount of active ingredient is the same, solvent is the same but the amount is 10.6%

| Surfactant mixture: | |
|---|---|
| polyarylphenol ethoxylated and | 6% |
| calcium dodecyl benzene sulfonate | 2% |
| Gelling agent: | |
| mixture of hexane diol and hexyne diol: | 11.5% |

These materials are mixed together at 90° C. while shearing with an attritor mixer. The product started to have the appearance of a smooth paste, and is a gel in a few minutes.

The brookfield viscosity of the gel is 2500 centipoises.

The emulsion stability is good in the above described test.

The spontaneity is 5.

1100 g of this gel are put in a 1 liter bag made of a film of PVA (88% hydrolysed polyvinyl acetate; cold water soluble; thickness: 55 microns). The bag, which is almost full (about 95% v/v), is heat sealed. The density both of the gel and of the bag containing the gel is 1.1.

The bag is then dropped 10 times from 1.2 m upon the ground. No breaking or leakage is observed.

The bag is put in a tank containing water under gentle agitation (that is to say such as that obtained with pump recycling). It is dispersed within a 5 minute interval. There is no clogging in the filter which is a 100 mesh screen.

### EXAMPLE 9

The procedure of example 4 is repeated, except a mixture containing the following components is used:

| Active ingredient: | |
|---|---|
| bromoxynil octanoate | 33.5% |
| bromoxynil heptanoate | 33.5% |
| Solvent: | |
| aromatic solvent with a flash point of 65° C.: | 17.5% |
| Surfactant: | |
| non ionic/sulfonate blended emulsifier | 4.5% |
| and calcium dodecyl benzene sulfonate | 1.0% |
| Gelling agent: | |
| sulfosuccinate and sodium benzoate | 4.25% |
| Antifoam: | |
| tetramethyl decyne diol | 0.5% |

These materials are mixed together at 50° C. while shearing with an attritor mixer. The product started to have the appearance of a smooth paste, and is a gel in a few minutes.

The brookfield viscosity of the gel is 4850 centipoises.

The emulsion stability is excellent in the above described test.

The spontaneity is 10.

1100 g of this gel are put in a 1 liter bag made of a film of PVA (88% hydrolysed polyvinyl acetate; cold water soluble; thickness: 55 microns). The bag, which is almost full (about 95% v/v), is heat sealed. The density both of the gel and of the bag containing the gel is 1.1 gm/cc.

The bag is then dropped 10 times from 1.2 m upon the ground. No breaking or leakage is observed.

The bag is put in a tank containing water under gentle agitation (that is to say such as that obtained with pump recycling). It is dispersed within a 3 minute interval. There is no clogging in the filter which is a 100 mesh screen.

We claim:

1. A water dispersible organic gel which is a continuous system comprising effective amounts of:
a hazardous product,
a water soluble or water dispersible surfactant which contains
a non ionic surfactant and
optionally an anionic surfactant, and
which is able to form above 50° C., a liquid phase with the active ingredient,
a gelling agent which/is either liquid or solid at 23° C. and which is soluble at less than 10% in the liquid mixture of active ingredient and surfactant above 50° C., this gelling agent having, when it is a solid, a particle size lower than 100 microns,
less than 3% by weight of water.

2. The water dispersible organic gel according to claim 1, wherein the water soluble or water dispersible surfactant is able to form above 70° C., a liquid phase with the active ingredient.

3. The water dispersible organic gel according to claim 1, wherein the gelling agent has, when it is solid, a particle size lower than 20 microns.

4. The water dispersible organic gel according to claim 1, containing less than 1% by weight of water.

5. The water dispersible organic gel according to claim 1 which further comprises the following components:
at least one organic solvent wherein the active ingredient is completely soluble at the given concentration,
a dispersant
a secondary thickener
other additives selected form the group of a stabilizer, an antifoaming agent, a buffer, an antifreezing agent.

6. The dispersible organic gel according to claim 5, which comprises the following quantities of components:
5 to 95% of the hazardous product,
1 to 50% of the surfactant,
0.1 to 50% of the gelling agent(s),
b 0 to 80% of the solvent.

7. The water dispersible organic gel according to claim 5 which comprises the following quantities of components:
25 to 80% of the hazardous product,
2 to 15% of the surfactant,
2 to 10% of the gelling agent(s),
3 to 50% of the solvent.

8. The water dispersible organic gel according to claim 6, which comprises the following quantities of components:
1 to 25% of the dispersant,
1 to 30% of the secondary thickener,
0.1 to 20% of said other additives.

9. The water dispersible organic gel according to claim 6 which comprises the following quantities of components:
2 to 8% of the dispersant,
1 to 25% of the secondary thickener,
0.1 to 10% of said other additives.

10. The water dispersible organic gel according to claim 1, having a viscosity of 600 to 30,000 centipoises.

11. The water dispersible organic gel according to claim 1, having a viscosity of 1000 to 12000 centipoises.

12. The water dispersible organic gel according to claim 1, which has a density greater than 1 specific gravity.

13. The water dispersible organic gel according to claim 1, having a density greater than 1.05 specific activity.

14. The water dispersible organic gel according to claim 1, which has a phase difference phi between the controlled shear stress and the resulting shear strain such that tg(phi) is less than or equal to 1.5.

15. The water dispersible organic gel according to claim 1, which has a phase difference phi between the controlled shear stress and the resulting shear strain such that tg(phi) is less than pr eqia; tp 1.2.

16. The water dispersible organic gel according to claim 1, wherein the hazardous product is an agrochemical.

17. The water dispersible organic gel according to claim 1, wherein the hazardous product is a plant protection agent or a plant growth regulator or a pesticide or a plant nutrient.

18. The water dispersible organic gel according to claim 1, which has a spontaneity less than 75.

19. The water dispersible organic gel according to claim 1, which has a sponetaneity less than 25.

20. A containerization system comprising a water dispersible organic gel according to claim 1, this gel being in a water soluble or water dispersible bag.

21. The containerization system according to claim 20 wherein the bag is made of a material selected from polyethylene oxide; starch and modified starch; alkyl and hydroxyalkylcellulose; carboxymethylcellulose; polyvinylethers; poly(2,4-dimethyl-6 triazolylethylene); poly(vinylsulfonic acid); polyanhydrides, ow-molecular weight urea-formaldehyde resins; low molecular weight melamine-formaldehyde resins; poly(2-hydroxyethyl methacrylate); polyacrylic acid and its homologs.

22 . The containerization system according to claim 21. wherein the bag is made of polyethylene glycol.

23. The containerization system according to claim 22, wherein the bag is made of hydroxy methylcellulose, hydroxyethylcellulose, or hydroxypropylcellulose.

24. The containerization system according to claim 23, wherein the bag is made of polymethylvinylether.

25. The containerization system according to claim 24, wherein the bag is made of polyethylene oxide or methylcellulose, or polyvinyl alcohol.

26. The containerization system according to claim 25, wherein the polyvinyl alcohol is partially or fully alcoholysed or hydrolysed to 40-100% polyvinyl acetate film.

27. The containerization system according to claim 25, wherein the polyvinyl alcohol is 80 -99% alcoholyzed or

28. The containerization system according to claim 20, wherein the bag is filled with the gel to at least 60% of capacity.

29. The containerization system according to claim 20, wherein the bag is filled with the gel to at least 70% of capacity.

30. The containerization system according to claim 20, wherein the bag is filled with the gel to at least 80 to 99% of capacity.

31. The containerization system according to claim 20, wherein the bag is filled with the gel to at least 85 to 95% of capacity.
